(19) United States
(12) Patent Application Publication
(10) Pub. No.: US 2025/0083172 A1
(43) Pub. Date: Mar. 13, 2025

(54) Tapered Paint Filter

(71) Applicant: Columbus Industries, Inc., El Paso, TX (US)

(72) Inventor: Mounir B.H. Slama, Dublin, OH (US)

(73) Assignee: Columbus Industries, Inc., El Paso, TX (US)

(21) Appl. No.: 18/882,065

(22) Filed: Sep. 11, 2024

Related U.S. Application Data
(60) Provisional application No. 63/598,176, filed on Nov. 13, 2023.
(60) Provisional application No. 63/537,934, filed on Sep. 12, 2023.
(60) Provisional application No. 63/537,614, filed on Sep. 11, 2023.

(51) Int. Cl. B05B 14/43; B05B 14/44

(52) U.S. Cl. CPC B05B 14/43; B05B 14/44

(57) ABSTRACT

A filter for industrial coating filtration systems that has a housing made up of a peripheral wall extending around a preferably rigid and pleated support backing with filtration media, which peripheral wall may be tapered. The housing is preferably made of a suitably rigid material. The support backing has openings so that gas can flow through without substantial resistance. Filtration media is mounted to or adjacent the support backing, end caps are attached to the ends of the support backing to maintain the pleated configuration, and the assembly is inserted into the housing. Tabs may extend from the support backing into slots in the end caps, and filtration material may be attached to the end caps to reduce or avoid unfiltered air passing through. Additional filtration material may be mounted to the opposite end cap sides to filter air passing between the end caps and the housing.

### BACKGROUND OF THE INVENTION

The invention relates generally to filters, and more particularly to filters made for applications where industrial coatings are applied.

Industrial coatings, such as automotive paint, are commonly applied to products in manufacturing facilities by spraying the products after placing the products in booths or stations that are separated from the rest of the manufacturing facility. Paint (which is a term used herein to include all industrial coatings) spraying creates “overspray” of atomized particles that do not adhere to the product's surface. Such particles are of various sizes, and can remain wet for some time. Therefore, in order to remove wet and dry overspray particles, paint arrestors are used to filter the air inside the paint booth prior to exhausting the air to the environment outside the paint booth.

Air filtration devices used in booths where painting by spraying is carried out are well known, such as in U.S. Pat. Nos. 3,075,337; 4,008,060; 4,894,073; 5,051,118; and 6,790,397. In the preceding patents, which are incorporated herein by reference, methods and apparatuses are disclosed describing how to take the dry and/or wet particles in suspension out of a gaseous flow, generally air.

To purify such gaseous flows an “inertia” filter can be used. An inertia filter causes turbulence in the flow of gas that contains the paint particles, thereby projecting the suspended particles against the walls of the filters due to the particles' inability to flow around the walls of the filters (because of the inertia of the paint particles and the air). These filters are known in the industry to be sold by Andreae Team, Inc. of Ardmore, Oklahoma. In inertia filters, the filters are of the pleated or accordion type and have walls made of air-impervious material, generally paperboard. These walls are connected along one or more folds and have different dimensions so that chambers are created between the walls. These walls have openings that are not aligned with each other along the direction of air flow. Thus, a turbulent flow of the gas is created within the chambers of the filter. This turbulent flow causes projection of the paint particles, due to the inertia of the particles, against the walls of the chambers where they are deposited. Inertia filters ensure a constant pressure drop over their lifetime but have the drawback that they do not retain small, light particles, the mass of which is insufficient for inertia to project them against the walls for deposition. For certain types of paint, particularly lacquers, these filters have an efficiency that cannot satisfy the more strict environmental standards.

Alternatively, filtration can be accomplished by screening/sieving, i.e. by passage of the gas and entrained particles through a porous media with tortuous paths causing impact of the particles with the media, and causing particles to be held when the particles encounter a tortuous path smaller than the particle. These filters typically do not retain dry particles having a size smaller than their pores. Thus, screening filters commonly have a low efficiency for paint particles. It is possible to make such filters with smaller pores to increase efficiency, but this introduces a substantial pressure drop across the media. Loading with particulate causes such screening filters to clog rapidly, thereby causing an increasing pressure drop, necessitating frequent replacement.

The filters now in use in this field have to be changed often, because government environmental standards generally require arrestance efficiencies greater than or equal to 98%. Filters that are able to meet these efficiency standards tend to require more frequent replacement due to filling with overspray more quickly. These filters are made by removable elements intended to be mounted in adapted frames, such as channels into which planar filter cartridges are inserted. The air flow is driven perpendicularly through the filter cartridges as in a residential heating, cooling and ventilation filtration system.

There is a need for an improved filter that has low pressure drop and high paint retention efficiencies, and that does not have to be replaced at a rate that either slows work substantially or causes the cost of use to be too high.

### SUMMARY OF THE INVENTION

Disclosed herein is a filter for a spray coating system. The filter comprises a housing including at least first, second, third, and fourth peripheral sidewalls having an inlet opening on a first side and an outlet opening on a second, opposite side. The inlet and outlet openings provide substantially no resistance to a flow of gas along a flow path extending through the housing from the inlet opening to the outlet opening. The filter comprises at least first and second substantially planar panels disposed within the peripheral sidewall between the inlet and outlet openings. The panels are interconnected together with the panels in a non-parallel relationship, wherein each of the panels has openings formed therethrough to provide substantially no resistance to the flow of gas. The first panel has at least first and third tabs extending from opposite first panel ends and the second panel has at least second and fourth tabs extending from opposite second panel ends. The first panel is disposed at a predetermined angle relative to the second panel. The filter comprises a filtration media disposed adjacent to the at least first and second panels and extending at least between the opposite first and second panel ends. The filter comprises a first end cap disposed within the housing adjacent and substantially parallel to the first housing sidewall. The first end cap has at least first and second slots spaced from one another, the first slot receiving the first tab extending from the first panel and the second slot receiving the second tab extending from the second panel, for maintaining the first panel at the predetermined angle relative to the second panel. The filter comprises a second end cap disposed within the housing adjacent and substantially parallel to the second housing sidewall at an opposite end of the first and second panels from the first end cap. The second end cap has at least third and fourth slots spaced from one another, the third slot receiving the third tab from the first panel and the fourth slot receiving the fourth tab from the second panel, for maintaining the first panel at the predetermined angle relative to the second panel. The filter comprises at least one layer of filtration material mounted to at least the first end cap. The at least one layer of filtration material extends across at least the first and second slots and attaches to a surface of the first end cap that faces the second end cap. The first and second tabs received by the first and second slots extend through openings in the filtration material that align with the corresponding first and second slots. The filtration material is disposed between the first end cap and corresponding ends of the first and second panels.

In some embodiments, a second layer of filtration material is mounted to the second end cap. The second layer of filtration material extends across at least the third and fourth slots and attaches to a surface of the second end cap that faces the first end cap. The third and fourth tabs received by the third and fourth slots extend through openings in the second layer of filtration material that align with the corresponding third and fourth slots. The second layer of filtration material is disposed between the second end cap and corresponding ends of the first and second panels

In some embodiments, the openings in the first and second layers of filtration material are slits.

In some embodiments, a third layer of filtration material is mounted to an opposite side of the first end cap from the at least one layer of filtration material. The third layer of filtration material is disposed between the first end cap and the first housing sidewall.

In some embodiments, a fourth layer of filtration material is mounted to an opposite side of the second end cap from the second layer of filtration material. The fourth layer of filtration material is disposed between the second end cap and the second housing sidewall.

In some embodiments, the filtration media disposed adjacent to the at least first and second panels extends between and beyond the opposite first and second panel ends, thereby overlapping the at least one layer of filtration material.

In some embodiment, first and second lips are disposed adjacent the inlet and the outlet openings and extend from opposite ends of the first end cap toward the second end cap. The first and second lips inhibit spray coating captured by the filtration media from flowing out of the filter.

In some embodiments, third and fourth lips extend from the third and fourth housing sidewalls toward one another and contact the first lip.

Disclosed herein is a filter for a spray coating system. The filter comprises a housing including at least first, second, third, and fourth peripheral sidewalls having an inlet opening on a first side and an outlet opening on a second, opposite side of the housing. The inlet and outlet openings provide substantially no resistance to a flow of gas along a flow path extending through the housing from the inlet opening to the outlet opening. The first and second sidewalls are substantially parallel, the third and fourth sidewalls are nonparallel and disposed at an angle to one another, and the first and second sidewalls have preferential folding lines along which the first and second sidewalls fold to collapse the housing. The filter comprises at least first and second substantially planar panels disposed within the peripheral sidewall between the inlet and outlet openings. The panels are interconnected together with the panels in a non-parallel relationship. Each of the panels has openings formed therethrough to provide substantially no resistance to the flow of gas. The first panel has at least first and third tabs extending from opposite first panel ends and the second panel has at least second and fourth tabs extending from opposite second panel ends. The first panel is disposed at a predetermined angle relative to the second panel. The filter comprises a filtration media disposed adjacent to the at least first and second panels and extending at least between the opposite first and second panel ends. The filter comprises a first end cap disposed within the housing adjacent and substantially parallel to the first housing sidewall. The first end cap has at least first and second slots spaced from one another. The first slot receiving the first tab extending from the first panel and the second slot receiving the second tab extending from the second panel maintain the first panel at the predetermined angle relative to the second panel. The filter comprises a second end cap disposed within the housing adjacent and substantially parallel to the second housing sidewall at an opposite end of the first and second panels from the first end cap. The second end cap has at least third and fourth slots spaced from one another. The third slot receiving the third tab from the first panel and the fourth slot receiving the fourth tab from the second panel maintain the first panel at the predetermined angle relative to the second panel.

In some embodiments, the preferential folding lines bisect the angle between the third and fourth sidewalls, whereby the housing may collapse to a substantially flat configuration.

In some embodiments, at least one layer of filtration material is mounted to at least the first end cap, the at least one layer of filtration material extends across at least the first and second slots and attaches to a surface of the first end cap that faces the second end cap. The first and second tabs received by the first and second slots extend through openings in the filtration material that align with the corresponding first and second slots. The filtration material is disposed between the first end cap and corresponding ends of the first and second panels.

In some embodiments, a second layer of filtration material is mounted to the second end cap, the second layer of filtration material extends across at least the third and fourth slots and attaches to a surface of the second end cap that faces the first end cap. The third and fourth tabs received by the third and fourth slots extend through openings in the second layer of filtration material that align with the corresponding third and fourth slots. The second layer of filtration material is disposed between the second end cap and corresponding ends of the first and second panels

In some embodiments, the openings in the first and second layers of filtration material are slits.

In some embodiments, a third layer of filtration material is mounted to an opposite side of the first end cap from the at least one layer of filtration material. The third layer of filtration material is disposed between the first end cap and the first housing sidewall.

In some embodiments, a fourth layer of filtration material is mounted to an opposite side of the second end cap from the second layer of filtration material. The fourth layer of filtration material is disposed between the second end cap and the second housing sidewall.

In some embodiments, the filtration media disposed adjacent to the at least first and second panels extends between and beyond the opposite first and second panel ends, thereby overlapping the at least one layer of filtration material.

In some embodiments, there are first and second lips adjacent the inlet and the outlet openings and extending from opposite ends of the first end cap toward the second end cap. The first and second lips inhibit spray coating captured by the filtration media from flowing out of the filter.

In some embodiments, third and fourth lips extend from the third and fourth housing sidewalls toward one another and contact the first lip.

In some embodiments, ends of the first lip adjoin corresponding ends of the third and fourth lips.

The polyester filtration material on the end caps serves as a gasket or supplemental filter to prevent air leakage between the filtration material and the surfaces that abut the filtration material, such as the top panel, bottom panel, panel section or any other abutting or seating structure. While the end caps and the top and bottom panels are in close proximity, filtration material in this gap prevents substantial bypass of the filtration media, because of the filtration material in this gap. Imperfections in the contact between the end caps and the top and bottom housing panels are filled with filtration material.

Where tabs extend through slits in the filtration material that extends over slots in the end caps, the filtration material seats tightly against the tab surfaces. This is because the slits are formed by merely slitting the filtration material, thereby removing no material. Therefore, the sides of each slit abut one another until a tab is extended through, at which point the sides of the slit abut the sides of the tab. Furthermore, there are overlapping edges of filtration media that extend over the filtration media, where a last layer of polyester in the filtration media may overlap the filtration material. This greatly reduces bypass of particles in the air through the filter apparatus without being filtered by media.

The filter disclosed herein may be installed in a device that is part of a filtration system in a paint booth or other industrial coating system in a manufacturing facility. The device may be a column or otherwise circular cylindrical, with shelves upon which the filter may rest, such as the Wenker brand Dry-Scrubber. The column may seat two or more filters (as disclosed herein) against one another on each shelf so that as the system draws air into the column, the air is first drawn through the filters. In this manner, the filters will filter the air of paint and other particles prior to the air entering the rest of the system.

### BRIEF DESCRIPTION OF DRAWINGS

FIG. 1 is a front view in perspective illustrating an embodiment of the present invention without filtration media;

FIG. 2 is a rear view in perspective illustrating the embodiment of FIG. 1;

FIG. 3 is a top view illustrating a housing of the FIG. 1 embodiment in an unassembled state;

FIG. 4 is a top view in perspective illustrating the housing of the FIG. 1 embodiment in an assembled state;

FIG. 5 is a front view illustrating the housing of FIG. 4 in a partially collapsed state;

FIG. 6 is a front view illustrating the housing of FIG. 4 in a mostly collapsed state;

FIG. 7 is a front view illustrating the housing of FIG. 4 in a fully collapsed state;

FIG. 8 is a top view illustrating the panel section of the FIG. 1 embodiment in an unassembled state;

FIG. 9 is a top view illustrating the end caps of the FIG. 1 embodiment in an unassembled state;

FIG. 10 is a front view in perspective illustrating the support of the FIG. 1 embodiment;

FIG. 11 is a rear view in perspective illustrating the support of the FIG. 1 embodiment;

FIG. 12 is a first side view in perspective illustrating the support of the FIG. 1 embodiment;

FIG. 13 is a second side view in perspective illustrating the support of the FIG. 1 embodiment;

FIG. 14 is a front view in perspective illustrating an embodiment of the present invention with filtration media;

FIG. 15 is a rear view in perspective illustrating an embodiment of the present invention with filtration media;

FIG. 16 is a top view illustrating the end caps of a second embodiment in an unassembled state;

FIG. 17 is a bottom view illustrating the end caps of the embodiment of FIG. 16 in an unassembled state;

FIG. 18 is a top view in perspective illustrating the interior of an embodiment of the present invention;

FIG. 19 is a bottom view in perspective illustrating the interior of an embodiment of the present invention;

FIG. 20 is a side view illustrating an end cap of the present invention;

FIG. 21 is an opposite side view illustrating the end cap of FIG. 20; and

FIG. 22 is a view in perspective illustrating an embodiment of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

The following U.S. Provisional Applications are incorporated in this application by reference: U.S. Provisional Application No. 63/537,614 filed Sep. 11, 2023, U.S. Provisional Application No. 63/537,934 filed Sep. 12, 2023 and U.S. Provisional Application No. 63/598,176 filed Nov. 13, 2023.

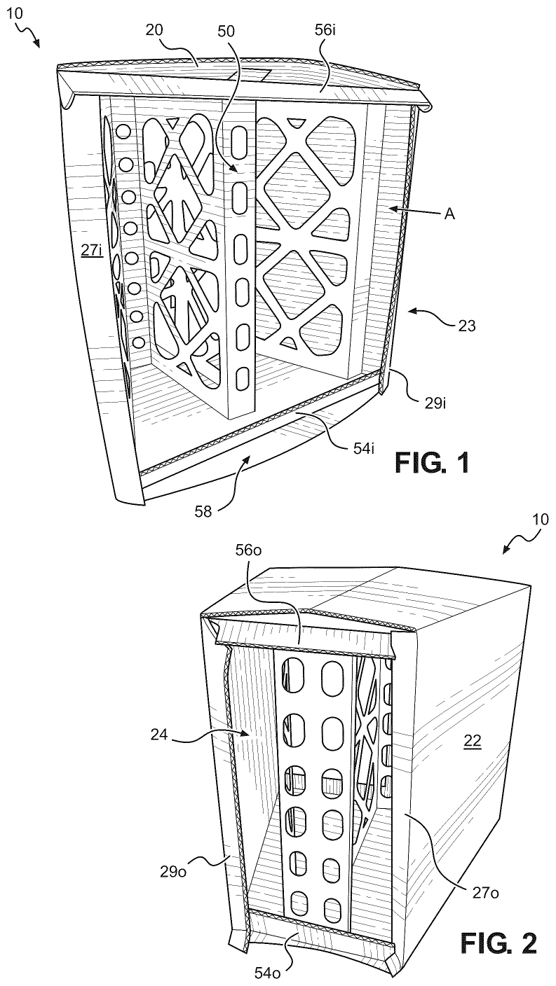

The filter 10 of FIGS. 1-2 has an outer housing 20 that encloses a support 50 for filtration media. The housing 20 can fold flat. The housing 20 is wedge-shaped with six sides, two of which are tapered. This is contrasted with the parallelepiped housing shape in U.S. Pat. Nos. 9,555,358, 9,993,835, 10,596,585, and 11,014,113, which are incorporated herein by reference. The opposing planar sides 21, 22 of the housing 20 are transverse to one another in an operable configuration, and join with the tapered sides of the top side panel and the bottom side panels. The sides 21, 22 may be at an angle of about 10-45 degrees, and more preferably about 20 degrees, to one another. The front side of the housing is the wider inlet end 23, and the rear side of the housing is the narrower outlet end 24, as shown in FIGS. 1-2. The top side panel 25 is parallel to the bottom side panel 26, and both are generally planar, in their operable configurations. The front and rear sides are generally parallel to one another and may have non-planar shapes.

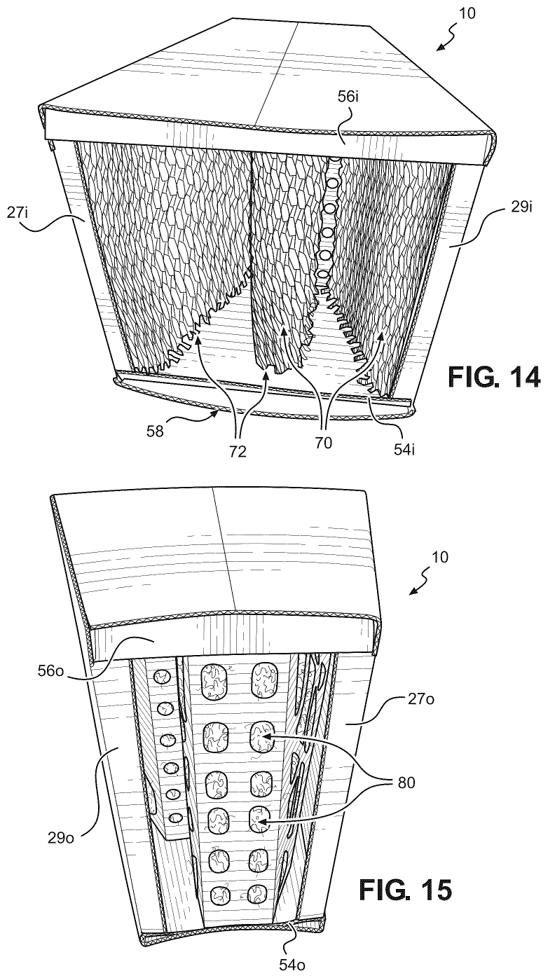

In several of the figures no filtration media is shown where media would be in a finished filter because the filtration media has been omitted to more readily view the support 50 and other features of the filter 10. Conventional slit and expanded paper, expanded paper layers adhesive-bonded into a pad, polymer, polyester, glass fiber, or other filtration media may be mounted to the support 50 or placed adjacent the support 50 without attaching as described in the patents incorporated by reference. Mounting to the support 50 may be by adhesive or by sewing, welding, fasteners or any other suitable means. Furthermore, in embodiments in which the media is mounted to the support 50, as well as embodiments in which the media is not mounted to the support 50, multiple layers of media may be held together in a pad or other structure by adhesive, sewing, welding, fasteners or any other suitable means. The more completed filter 10 is shown in FIGS. 14-15 with the filtration media 70 (e.g., slit and expanded paper) and 80 (e.g., polyester) in an operable position, whether attached to the support 50 or disposed adjacent but not attached.

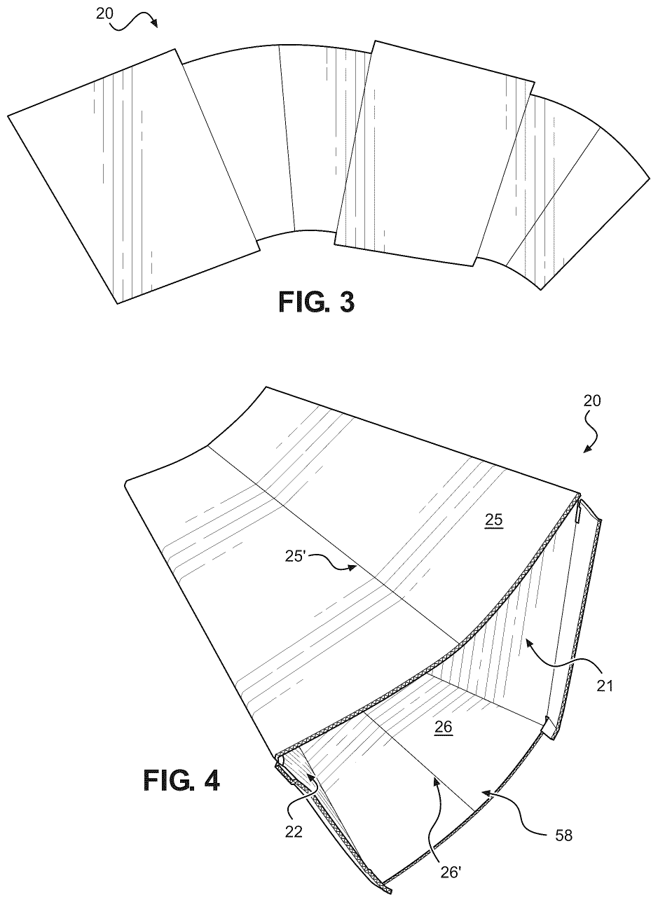

In FIG. 3, the housing 20 is shown separate from the support 50 after being formed, for example, after being cut out of a paperboard or corrugated cardboard sheet. This flat “blank” shown in FIG. 3 is subsequently folded and its ends are glued together to form a configuration that can be collapsed or expanded. In FIG. 4, the housing 20 is shown in its completed configuration and is at, or close to, fully expanded. The housing 20 has openings in the inlet end 23 and in the opposite outlet end 24, as shown in FIGS. 1-2 and the openings present no substantial resistance to air flow through the housing 20. The inlet end 23 opening is larger than the outlet end 24 opening. Both openings may have lips 27i, 270, 29i, and 290 on opposing sides, which may interact with lips (e.g., top and bottom lips 54i, 56i, 540 and 560) on the support 50 as described in more detail herein.

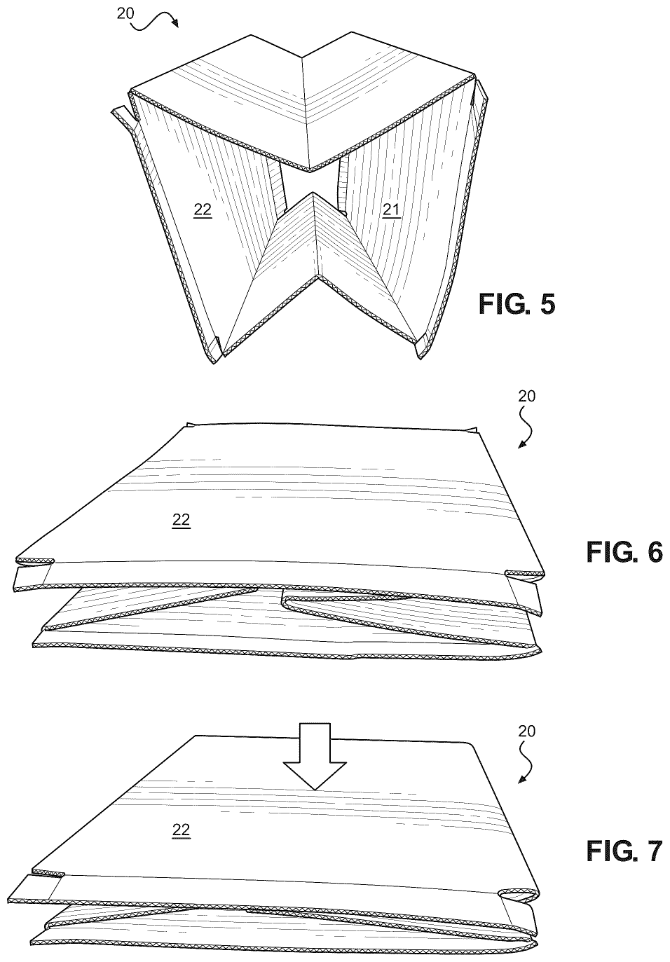

In FIG. 5, the housing 20 is shown in a partially collapsed configuration. Collapsing from an expanded configuration occurs when the user presses inwardly on the top panel 25 and the bottom panel 26, which may be scored, perforated or otherwise deliberately weakened along the lines 25′ and 26′, respectively (see FIG. 4). The lines 25′ and 26′ preferably bisect an angle formed by the edges of the transverse planar sides 21, 22. With a small force, the top and bottom panels 25, 26 fold along the lines 25′, 26′ and may be displaced inwardly, as shown in FIG. 5. The housing 20 is shown in an almost fully collapsed configuration in FIG. 6 and in a fully collapsed configuration in FIG. 7 in which the sides 21 and 22, and the top 25 and bottom 26 are substantially parallel to one another and in close proximity to one another. By collapsing as shown, the housing 20 may be in a flat, relatively slim, planar form, which is efficiently transported to the end user. Because the lines 25′ and 26′ bisect the angle of the planar sides 21, 22, the collapse of the housing 20 is symmetrical, with about half of the housing 20 on one side of the lines 25′, 26′ and half on the other side.

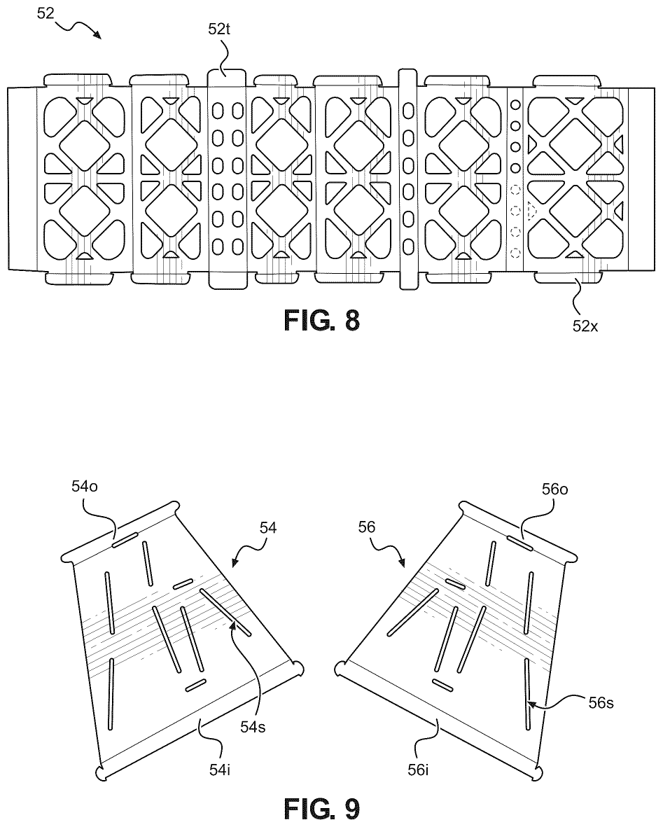

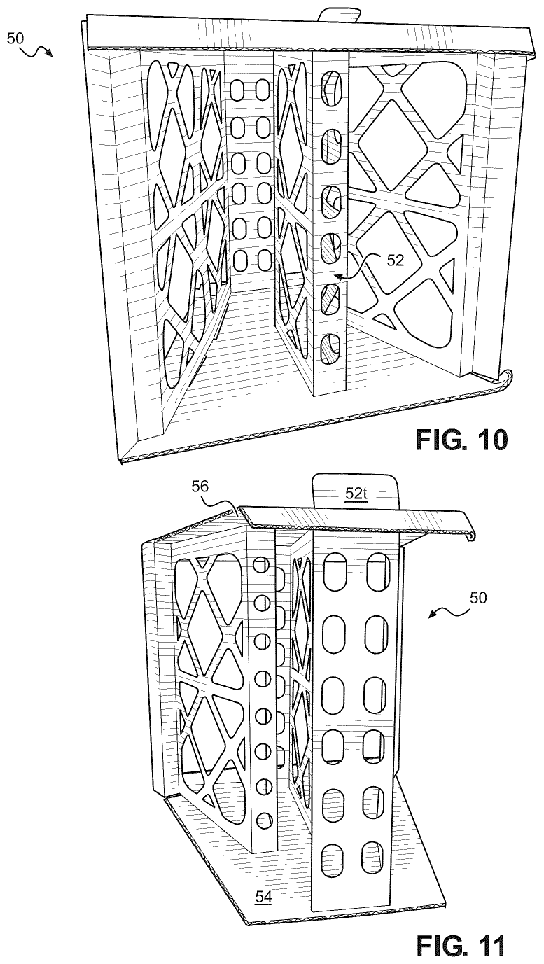

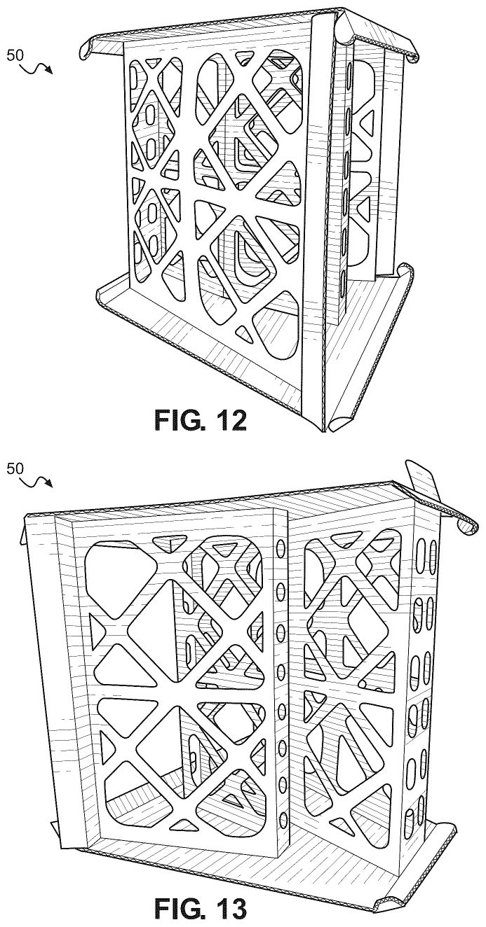

The components of the support 50 are shown separate from one another in FIGS. 8-9, and in FIGS. 10-13 the support 50 is shown assembled, but apart from the housing 20 and without filtration media. The support 50 has a panel section 52 that may be folded from a planar configuration (FIG. 8) into numerous planar panels angled non-parallel relative to one another. Each panel has large openings so that there is no substantial resistance to air flow through the panel section 52. The support 50 also has two end caps 54 and 56 that are shown in FIG. 9 and are mirror images of one another. One end cap 54 is mounted to the bottom of the panel section 52 when the panel section 52 is folded as shown in FIGS. 10-13, and one end cap 56 is mounted to the top of the folded panel section 52 when the panel section 52 is folded as shown in FIGS. 10-13. The terms “top,” “bottom,” and “sides” refer to locations when the filter 10 is in the preferred operable orientation, and should not be limiting.

In one embodiment, the end caps have slots (e.g., 54s and 56s) into which the tabs (e.g., 52t and 52x) may be inserted when the support 50 is fully assembled as shown in FIGS. 10-13. The insertion of the tabs through the slots provides sufficient strength as a fastening means to cause the panel section 52 to maintain the relative positions of its numerous panels to one another and relative to the end caps 54 and 56. Further fastening by glue, staples or other fasteners optionally enhances the strength and security of the tabs in the slots. When the support 50 is installed in the housing 20, each of the tabs may fold downwardly to be substantially parallel with the plane containing the corresponding end cap. This aids in preventing removal of the tabs from the slots until removal is desired.

It is contemplated that the support 50, with or without end caps 54 and 56 attached, may be completely, or partially, collapsed to a more compact form for transport. For example, the support 50 may be folded to the configuration shown in FIGS. 10-13, and then further collapsed by folding the support 50 to reduce the angles between planar panels. The support may be collapsed with the end caps 54 and 56 partially or fully attached to the panel section 52 (i.e., with some or all tabs in corresponding slots), or without the end caps attached to the panel section 52. The end caps 54 and 56 may have slits or preferential fold lines so that they are collapsible, as with the end caps in the patents incorporated above by reference. Collapsible end caps may fold with the panel section 52.

The completed support 50 is shown in FIGS. 10-13 from the front (air inlet), rear (air exhaust), right side and left side, respectively, and these views correspond to the inlet end 23, outlet end 24, first side 22 and opposite second side 21, respectively. As noted above, no filtration media is mounted to or adjacent the support 50 shown in FIGS. 10-13. The media would be attached or adjacent the support 50 in a completed filter, and the media is omitted from FIGS. 10-13 to permit better viewing of the support 50 and its component structures. As an alternative to a filtration media layer being mounted to the support 50, a filtration media layer may be positioned adjacent the support 50, preferably on the side of the support 50 where air flow in a path strikes the support 50, typically referred to as the “upstream” side of the support 50. No attachment of the filtration media layer to the support 50 may be necessary when the air passing through the filtration media layer urges the filtration media layer against the support 50 sufficiently to maintain the filtration media layer in position relative to the support 50.

The support 50 as shown in FIGS. 10-13, or with a filtration media layer attached, may be inserted into the expanded housing 20 to construct the final filtration product, i.e., the completed filter 10. The filter 10 may rest on a shelf with a rounded front edge. The housing 20 protects the rounded front edge of the metal shelf by the rounded front lip 58 at the air inlet end. The direction of airflow into the filter 10 is shown in FIG. 1 by the arrow, A.

The inlet end 23 of the housing 20 has right and left lips 27i and 29i that extend vertically on opposite inlet sides of the housing 20. The planes that contain the lips are substantially perpendicular to the direction of air flow, as shown in FIGS. 1 and 14 in an operable orientation. The opposite, outlet end 24 of the housing 20 has left and right lips 270 and 290 that extend vertically on both sides of the housing 20. The planes that contain the lips are substantially perpendicular to the direction of air flow, as shown in FIGS. 2 and 15 in an operable orientation. The lips are preferably an extension of the housing 20 side panels 21 and 22, from which the lips are bent.

The bottom end cap 54 has an inlet end lip 54i and an outlet end lip 540, and the top end cap 56 has an inlet end lip 56i and an outlet end lip 560. The end cap lips 540, 54i, 560, and 56i are in a plane that is substantially perpendicular to air flow in an operable configuration and are preferably extensions from the end caps from which the lips are bent. The end cap lips may be joined with the lips 27i, 270, 29i and 290 at the inlet end and the outlet end, as shown in FIGS. 1, 2, 14 and 15. The lips may attach at overlapping ends to one another, such as by adhesive, stitching or other fasteners to form a narrow inlet face and a narrow outlet face that are both substantially perpendicular to air flow. The lips also retain paint in the support 50, particularly the lips 54i and 540 on the bottom end cap to which paint runs by gravitational force. The lips 54i and 540 join with the lateral lips 27i, 270, 29i, and 290 on the housing 20 to create end walls that hold significant paint at the bottom of the filter 10 before overflowing out of the filter 10 over the lips. In order to hold more paint, the lips, particularly lips 540 and 54i, may be constructed to be taller, thereby creating a taller end wall in the filter 10.

The completed filter 10 is wedge-shaped to fit into a wedge-shaped space in a metal or other frame that is known to those in the paint filtration industry.

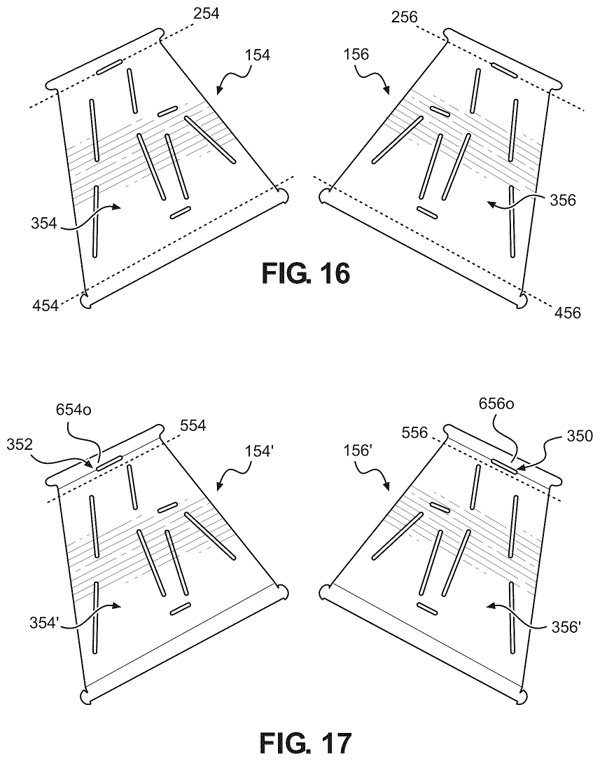

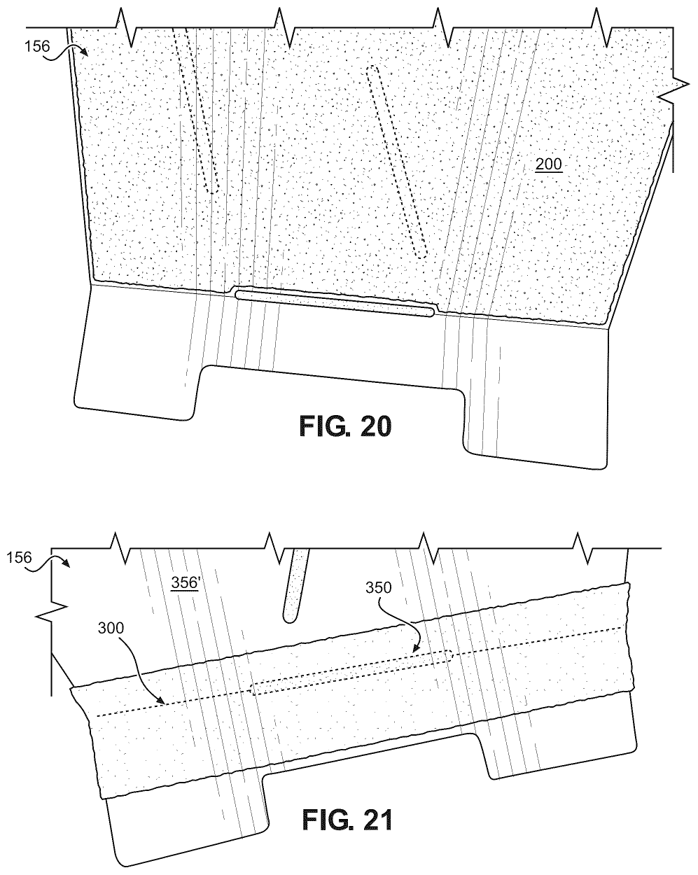

In an embodiment illustrated in FIGS. 16 and 18-20, the end caps 154 and 156, which are substantially similar to the end caps 54 and 56, have a filtration material attached to at least one side. The filtration material preferably filters airflow through spaces or gaps adjacent the end caps 154 and 156 that might escape the filter 10 without being filtered. The filtration material is preferably a porous polyester material, similar to that used for filtration purposes, but can be any filtration material that permits the flow of air therethrough and the attachment of paint particles thereon, including without limitation slit and expanded paper, fiberglass or polymer non-woven or batts, fabric or felt. The filtration material is preferably about 1.0-5.0 millimeters thick, but can be as much as 2.0 centimeters thick or as little as 0.01 millimeters.

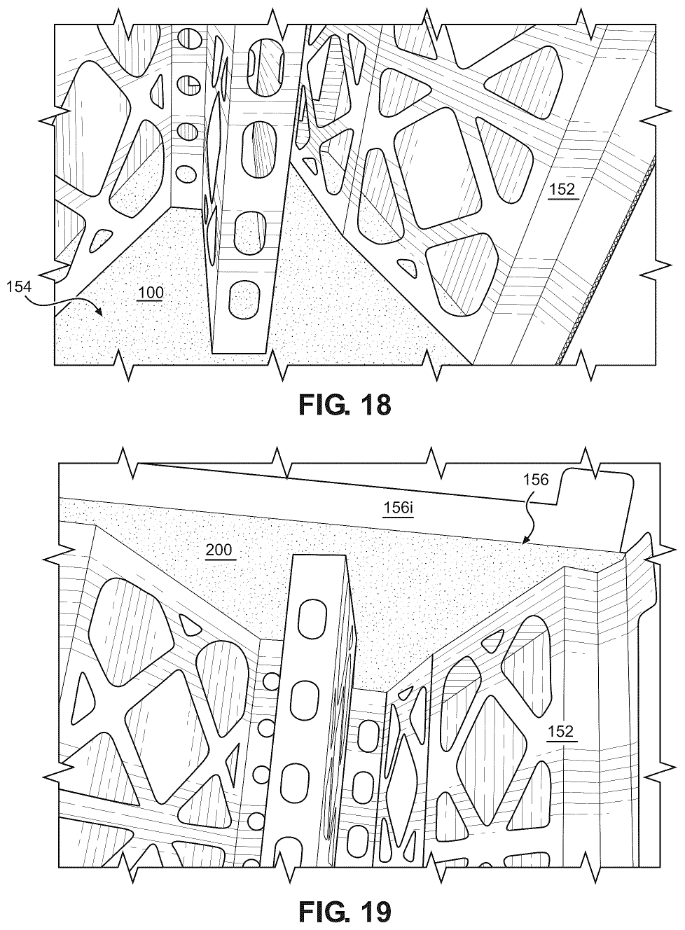

The filtration material attaches to the surfaces 354 and 356, which are preferably the surfaces that face one another when the filter is completed. The filtration material preferably extends laterally to the lateral edges and longitudinally to the fold lines for the front and rear lips of each end cap. In the end cap examples shown in FIG. 16, the filtration material attaches to the surface 354 of the end cap 154 and extends from side to side and from about the line 254 to about the line 454. The filtration material attaches to the surface 356 of the end cap 156 and extends from side to side and from about the line 256 to about the line 456. The filtration material is preferably adhered, sewn or otherwise fastened parallel to the surface to which it is attached.

Where a slot is located on the end caps 154 and 156, the slot is preferably formed by removing material to make an opening that may receive a tab extending from the panel section 152 (FIGS. 18-19), as with the embodiments discussed herein. Ordinarily, the slots are larger than the tabs that will extend into the slots to account for the thickness and length of the tabs and imperfections in manufacturing. However, where the filtration material covers a slot, the filtration material is slit along the length of the slot using a sharp blade (e.g., through and/or aligned with the corresponding slot), which blade does not remove any material from the filtration material. This forms a slit, but not an opening with a substantial or measurable width, through the filtration material. Instead, the slit separates the filtration material but the sides of the slit are in contact until a tab is inserted to separate the sides. Thus, when a tab is inserted into the slot, the filtration material separates the sides of the slit and permits the tab to pass through the slot. The tab is thicker than the slit so that after the filtration material is forced open the slit sides rest against the sides of the tab. This tight relationship prevents gaps from forming between the tab and the slit side through which air could pass without being filtered by the filtration material. Thus, the filtration material forms a “gasket” to inhibit air passage through the gap between the tab and the end cap, and substantially enhances the hermetic properties of the filter 10, especially with respect to fine particles.

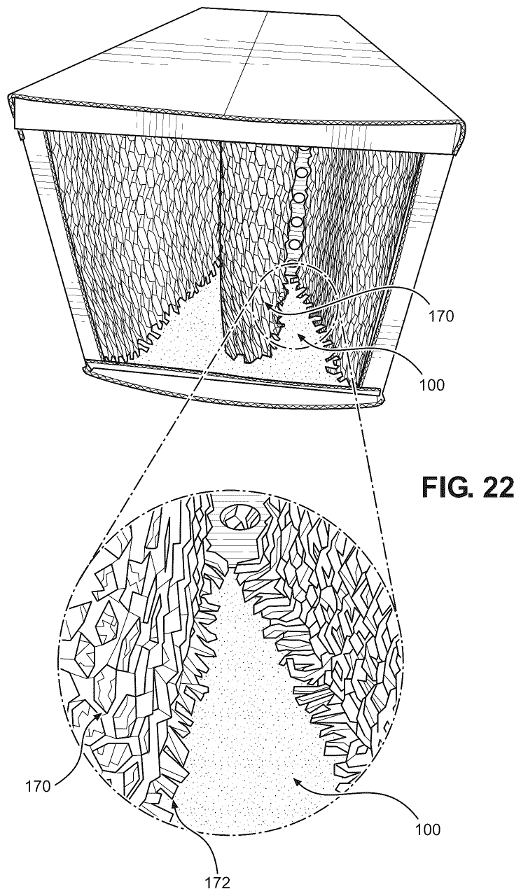

The filtration material 100 is shown in an operable configuration in FIG. 18 attached to the bottom end cap 154 where the panel section 152 is attached to the end cap 154. In a completed embodiment, filtration media is disposed adjacent the panel section 152 (as shown by reference numerals 70 and 80 in the embodiment of FIGS. 14-15) and abuts the filtration material 100. The ends of the filtration media on the panel section 152 are preferably slightly longer than the panel section 152, and thus extend over the filtration material 100 (see FIG. 14 at 72 and FIG. 22 at 172, which shows filtration material 100 and adjacent, overlapping filtration media 170). This overlap of the filtration media on the panel section 152 and the filtration material 100 on the end cap 154 prevents air from passing between the end cap 154 and the panel section 152 without passing through filtration media and/or filtration material 100. Preferably, the filtration material 100 seats against the rear filtration layer of the filtration media 170, which may also be polyester. Thus, any air passing through is filtered.

The filtration material 200 is shown in an operable configuration in FIG. 19 attached to the top end cap 156 where the panel section 152 is attached to the end cap 156. In a completed embodiment, filtration media is disposed adjacent the panel section 152 and abuts the filtration material 200. The ends of the filtration media on the panel section 152 are preferably slightly longer than the panel section 152, and thus extend over the filtration material 200 (see FIG. 14 at 72 and FIG. 22 at 172). This overlap of the filtration media on the panel section 152 and the filtration material 200 on the end cap 156 prevents air from passing between the end cap 156 and the panel section 152 without passing through filtration media and/or filtration material 100. Preferably, the filtration material 200 seats against the rear filtration layer of the filtration media 170, which may also be polyester. Thus, any air passing through is filtered.

In FIG. 19 it is apparent that the material 200 extends to about the fold line of the lip 156i shown bent upwardly in FIG. 19 in the inlet end of the filter. In a completed filter, the lip 156i is bent down from the position shown in FIG. 19 toward the panel section 152 in an operable configuration that is substantially perpendicular to air flow.

In another embodiment shown in FIG. 17, which may be the same as the embodiment of FIGS. 16 and 18-20, a filtration material 300 is mounted to the end caps 154′ and 156′. The filtration material may be the same filtration material as described above attached to the surfaces 354 and 356. The filtration material 300 preferably attaches to the surfaces 354′ and 356′ that face away from one another when the filter is completed, and extend some distance down the lips 6540 and 6560, possibly the entire distance. As shown in FIG. 17, there are slots 350 and 352 on the folds of the lips 6560 and 6540, respectively on the end caps 356′ and 354′. The filtration material 300 extends over the slots 350 and 352, as shown over the slot 350 (as an example of both) in FIG. 21, which is a view of the end cap 156′ showing the surface 356′ and the slot 350. The end cap 154′ is substantially the same as shown in FIG. 21. The filtration material 300 on the end caps 154 and 156 preferably seats against the top and bottom panels 25 and 26 of the housing 20, so that any air passing between either of the end caps and the housing 20 across the entire width of the housing 20 at the outlet end 24 is stopped or filtered by the filtration material 300 sandwiched therebetween.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A filter for a spray coating system, the filter comprising:
(a) a housing including at least first, second, third, and fourth peripheral sidewalls having an inlet opening on a first side and an outlet opening on a second, opposite side of the housing, the inlet and outlet openings providing substantially no resistance to a flow of gas along a flow path extending through the housing from the inlet opening to the outlet opening;
(b) at least first and second substantially planar panels disposed within the peripheral sidewall between the inlet and outlet openings, the panels being interconnected together with the panels in a non-parallel relationship, wherein each of the panels has openings formed therethrough to provide substantially no resistance to the flow of gas, wherein the first panel has at least first and third tabs extending from opposite first panel ends and the second panel has at least second and fourth tabs extending from opposite second panel ends, wherein the first panel is disposed at a predetermined angle relative to the second panel;
(c) a filtration media disposed adjacent to the at least first and second panels and extending at least between the opposite first and second panel ends;
(d) a first end cap disposed within the housing adjacent and substantially parallel to the first housing sidewall, the first end cap having at least first and second slots spaced from one another, the first slot receiving the first tab extending from the first panel and the second slot receiving the second tab extending from the second panel, for maintaining the first panel at the predetermined angle relative to the second panel;
(e) a second end cap disposed within the housing adjacent and substantially parallel to the second housing sidewall at an opposite end of the first and second panels from the first end cap, the second end cap having at least third and fourth slots spaced from one another, the third slot receiving the third tab from the first panel and the fourth slot receiving the fourth tab from the second panel, for maintaining the first panel at the predetermined angle relative to the second panel; and
(f) at least a first layer of filtration material mounted to at least the first end cap, the first layer of filtration material extending across at least the first and second slots and attaching to a surface of the first end cap that faces the second end cap, wherein the first and second tabs received by the first and second slots extend through openings in the first layer of filtration material that align with the corresponding first and second slots, and wherein the first layer of filtration material is disposed between the first end cap and corresponding ends of the first and second panels.

2. The filter in accordance with claim 1, further comprising a second layer of filtration material mounted to the second end cap, the second layer of filtration material extending across at least the third and fourth slots and attaching to a surface of the second end cap that faces the first end cap, wherein the third and fourth tabs received by the third and fourth slots extend through openings in the second layer of filtration material that align with the corresponding third and fourth slots, and wherein the second layer of filtration material is disposed between the second end cap and corresponding ends of the first and second panels.

3. The filter in accordance with claim 2, wherein the openings in the first and second layers of filtration material are slits.

4. The filter in accordance with claim 2, further comprising a third layer of filtration material mounted to an opposite side of the first end cap from the first layer of filtration material, the third layer of filtration material disposed between the first end cap and the first housing sidewall.

5. The filter in accordance with claim 4, further comprising a fourth layer of filtration material mounted to an opposite side of the second end cap from the second layer of filtration material, the fourth layer of filtration material disposed between the second end cap and the second housing sidewall.

6. The filter in accordance with claim 1, wherein the filtration media disposed adjacent to the at least first and second panels extends between and beyond the opposite first and second panel ends, thereby overlapping the first layer of filtration material.

7. The filter in accordance with claim 1, further comprising first and second lips adjacent the inlet and the outlet openings and extending from opposite ends of the first end cap toward the second end cap, whereby the first and second lips inhibit spray coating captured by the filtration media from flowing out of the filter.

8. The filter in accordance with claim 7, further comprising third and fourth lips extending from the third and fourth housing sidewalls toward one another and contacting the first lip.

9. A filter for a spray coating system, the filter comprising:
(a) a housing including at least first, second, third, and fourth peripheral sidewalls having an inlet opening on a first side and an outlet opening on a second, opposite side of the housing, the inlet and outlet openings providing substantially no resistance to a flow of gas along a flow path extending through the housing from the inlet opening to the outlet opening, wherein the first and second sidewalls are substantially parallel, the third and fourth sidewalls are nonparallel and disposed at an angle to one another, and the first and second sidewalls have preferential folding lines along which the first and second sidewalls fold to collapse the housing;
(b) at least first and second substantially planar panels disposed within the peripheral sidewall between the inlet and outlet openings, the panels being interconnected together with the panels in a non-parallel relationship, wherein each of the panels has openings formed therethrough to provide substantially no resistance to the flow of gas, wherein the first panel has at least first and third tabs extending from opposite first panel ends and the second panel has at least second and fourth tabs extending from opposite second panel ends, wherein the first panel is disposed at a predetermined angle relative to the second panel;
(c) a filtration media disposed adjacent to the at least first and second panels and extending at least between the opposite first and second panel ends;
(d) a first end cap disposed within the housing adjacent and substantially parallel to the first housing sidewall, the first end cap having at least first and second slots spaced from one another, the first slot receiving the first tab extending from the first panel and the second slot receiving the second tab extending from the second panel, for maintaining the first panel at the predetermined angle relative to the second panel; and
(e) a second end cap disposed within the housing adjacent and substantially parallel to the second housing sidewall at an opposite end of the first and second panels from the first end cap, the second end cap having at least third and fourth slots spaced from one another, the third slot receiving the third tab from the first panel and the fourth slot receiving the fourth tab from the second panel, for maintaining the first panel at the predetermined angle relative to the second panel.

10. The filter in accordance with claim 9, wherein the preferential folding lines bisect the angle between the third and fourth sidewalls, whereby the housing is configured to collapse to a substantially flat configuration.

11. The filter in accordance with claim 9, further comprising at least a first layer of filtration material mounted to at least the first end cap, the first layer of filtration material extending across at least the first and second slots and attaching to a surface of the first end cap that faces the second end cap, wherein the first and second tabs received by the first and second slots extend through openings in the filtration material that align with the corresponding first and second slots, and wherein the filtration material is disposed between the first end cap and corresponding ends of the first and second panels.

12. The filter in accordance with claim 11, further comprising a second layer of filtration material mounted to the second end cap, the second layer of filtration material extending across at least the third and fourth slots and attaching to a surface of the second end cap that faces the first end cap, wherein the third and fourth tabs received by the third and fourth slots extend through openings in the second layer of filtration material that align with the corresponding third and fourth slots, and wherein the second layer of filtration material is disposed between the second end cap and corresponding ends of the first and second panels.

13. The filter in accordance with claim 12, wherein the openings in the first and second layers of filtration material are slits.

14. The filter in accordance with claim 12, further comprising a third layer of filtration material mounted to an opposite side of the first end cap from the first layer of filtration material, the third layer of filtration material disposed between the first end cap and the first housing sidewall.

15. The filter in accordance with claim 14, further comprising a fourth layer of filtration material mounted to an opposite side of the second end cap from the second layer of filtration material, the fourth layer of filtration material disposed between the second end cap and the second housing sidewall.

16. The filter in accordance with claim 12, wherein the filtration media disposed adjacent to the at least first and second panels extends between and beyond the opposite first and second panel ends, thereby overlapping the at least one layer of filtration material.

17. The filter in accordance with claim 9, further comprising first and second lips adjacent the inlet and the outlet openings and extending from opposite ends of the first end cap toward the second end cap, whereby the first and second lips inhibit spray coating captured by the filtration media from flowing out of the filter.

18. The filter in accordance with claim 17, further comprising third and fourth lips extending from the third and fourth housing sidewalls toward one another and contacting the first lip.

19. The filter in accordance with claim 18, wherein ends of the first lip adjoin corresponding ends of the third and fourth lips.
